(19) United States
(12) Patent Application Publication
(10) Pub. No.: US 2001/0016053 A1
(43) Pub. Date: Aug. 23, 2001

(54) MULTI-SPECTRAL IMAGING SENSOR

(76) Inventors: MONTE A. DICKSON, NAPERVILLE, IL (US); LARRY L. HENDRICKSON, NAPERVILLE, IL (US); JOHN F. REID, CHAMPAIGN, IL (US)

Correspondence Address: FOLEY & LARDNER, FIRSTAR CENTER, 777 EAST WISCONSIN AVENUE, MILWAUKEE, WI, 532025367

(21) Appl. No.: 09/411,414

(22) Filed: Oct. 1, 1999

Related U.S. Application Data
(63) Continuation-in-part of application No. 08/948,637, filed on Oct. 10, 1997, now Pat. No. 6,160,902.

(51) Int. Cl. G06K 9/00

(52) U.S. Cl. 382/110

(57) ABSTRACT

An apparatus and method is disclosed for producing a plurality of video signals to be processed by an image processor, where the video signals are representative of light reflected from a source region, such as a segment of an agricultural field. The apparatus includes a light receiving unit for receiving the light reflected from the source region and a multi-spectral sensor coupled to the light receiving unit for converting the light received by the light receiving unit into the video signals. The multi-spectral sensor includes a prism for dividing the light received by the light receiving unit into a plurality of light components, a plurality of light-detecting arrays each having a plurality of pixels for receiving the light components and producing electronic signals in response thereto, and a sensor control circuit for converting the electronic signals into video signals and for controlling the responsiveness of the pixels of the light detecting arrays to the light components. The light may be received by the light receiving unit at a variety of locations, such as on an agricultural vehicle, on an aircraft, or on a satellite. Also disclosed is use of an ambient light sensor to determine an ambient light level based upon which the video signals may be adjusted, and use of a light source to provide additional light to the source region. Further, an apparatus and method is disclosed for producing images of an agricultural field, based upon the video signals, that may be analyzed in real time for characteristics such as the nitrogen content of crops, and for storing such images for later analysis.

### CROSS-REFERENCE TO RELATED APPLICATIONS

This application is a continuation-in-part of application Ser. No. 08/948,637, filed Oct. 10, 1997, for Method for Monitoring Nitrogen Status Using a Multi-Spectral Imaging System.

### FIELD OF THE INVENTION

This invention relates to an apparatus and method for producing a multi-spectral image of a source region and more specifically, to an apparatus and method for using a multi-spectral sensor which detects light reflected at multiple wavelengths from a source region and analyzes the reflected light to determine characteristics of the source region.

### BACKGROUND OF THE INVENTION

Monitoring of crops in agriculture is necessary to determine optimal growing conditions to improve and maximize yields. Maximization of crop yields is critical to the agricultural industry due to the relatively low profit margins involved. Crop conditions in a particular field or area are analyzed for factors such as plant growth, irrigation, pesticides, etc. The results of the analyses may be used to identify planting problems, estimate yields, adjust irrigation schedules and plan fertilizer application. The status of the crops is monitored throughout the growing cycle in order to insure that maximum crop yields may be achieved. Optimum crop development requires maintenance of high levels of both chlorophyll and nitrogen in plants. As it is known that plant growth correlates with chlorophyll concentration, finding of low chlorophyll concentration levels is indicative of slower growth and ultimately a yield loss. Since there is a direct relationship between the nitrogen and chlorophyll levels in plants, a finding of low chlorophyll may signal the existence of low levels of nitrogen. Thus, in order to improve crop growth, farmers add nitrogen fertilizers to the soil to increase chlorophyll concentration and stimulate crop growth. Fertilizer treatments, if applied early in the crop growth cycle, can insure that slower growing crops achieve normal levels of growth.

Monitoring nitrogen levels in crops, vis-a-vis chlorophyll levels, allows a farmer to adjust application of fertilizer to compensate for shortages of nitrogen and increase crop growth. Accurate recommendations for fertilizer nitrogen are desired to avoid inadequate or excessive application of nitrogen fertilizers. Excessive amounts of fertilizer may reduce yields and quality of certain crops. Additionally, over-application of fertilizer results in added costs to a farmer, as well as increasing the potential for nitrate contamination of the environment. Thus, it is critical to obtain both accurate and timely information on nitrogen levels.

One known method of determining the nitrogen content in plants and soil involves taking samples of plants and soil and performing chemical testing. However, this method requires considerable time and repeated sampling during the growing season. Additionally, a time delay exists from the time the samples are taken to the time when the nitrogen levels are ascertained and when fertilizer may be applied due to the time required for laboratory analysis. Such delay may result in the delayed application of corrective amounts of fertilizer, which may then be too late to prevent stunted crop growth.

In an effort to eliminate the delay between the times of nitrogen measurement and the application of corrective fertilizer, it has been previously suggested to utilize aerial or satellite photographs to obtain timely data on field conditions. This method involves taking a photograph from a camera mounted on an airplane or a satellite. Such photos are compared with those of areas which do not have nitrogen stress. Such a method provides improvement in analysis time but is still not real time. Additionally, it requires human intervention and judgment. Information about crop status is limited to the resolution of the images. When such aerial images are digitized, a single pixel may represent an area such as a square meter. Insufficient resolution prevents accurate crop assessment. Other information which might be gleaned from higher resolution images cannot be measured.

Another approach uses a photodiode mounted on ground-based platforms to monitor light reflected from a sensed area. The image is analyzed to determine the quantity of light reflected at specific wavelengths within the light spectrum of the field of view. Nitrogen levels in the crops have been related to the amount of light reflected in specific parts of the light spectrum, most notably the green and near infrared wavelength bands. Thus, the reflectance of a crop may be used to estimate the nitrogen for the plants in that crop area.

In contradistinction, however, the photodiode sensing methods suffer from inaccuracies in the early part of the crop growth cycle because the overall reflectance values are partially derived from significant areas of non-vegetation backgrounds, such as soil, which skew the reflectance values and hence the nitrogen measurements. Additionally, since one value is used, this method cannot account for deviations in reflectance readings due to shadows, tassels and row orientation of the crops.

Increasing spatial and spectral resolution can produce a more accurate image, which provides improved reflectance analysis as well as being able to differentiate individual rows or plants. However, current high resolution remote sensing approaches have met with little success because of the tremendous volumes of data generated when used over large areas at the necessary high resolutions. These methods are difficult to implement because of the large amount of data which must be stored or transferred for each image. Moreover, the accuracy of existing remote imaging devices is adversely affected by the wide range of ambient light conditions which may exist at the time the remote sensing is performed. In particular, light-sensing elements of existing imaging devices have a constant exposure period for gathering light, with the period being pre-selected so that the light-sensing elements do not oversaturate in relatively bright ambient light conditions and operate above noise-equivalent levels in dim ambient light conditions. The need for a single exposure period for light-sensing elements which is capable of accommodating both relatively bright and dim ambient light conditions requires a corresponding trade-off in the dynamic range of the sensed signal since the ambient light will be at a relatively constant level during a particular remote sensing period. The reduced dynamic range will result in a less accurate sensed signal.

Furthermore, in current high resolution remote imaging devices, only particular sensed light components are utilized to make determinations as to plant activity and, consequently, the ability of users of these devices to obtain accurate nitrogen measurements is limited. Certain existing devices sense only two primary light components, infrared light and a single additional visible light component (typically red light). A user of such devices is expected to make judgements as to plant activity based solely upon the relative strength of these two primary light components. Although other existing devices may sense supplementary visible light components (e.g., green light) in addition to these two primary light components, the devices still operate to sense plant activity based upon the relative strength of the primary light components. Indeed, in these devices, one light diffraction element is used for separating the two primary light components from one another and a second light diffraction element is needed for separating the various visible light components from one another.

Thus, there is a need for a high-resolution image sensor which can sense detailed, highly-variable reflected light patterns from crops, and which has light-sensing elements which can adapt to a wide range of ambient light conditions while simultaneously providing a sensed signal having a high dynamic range. Further, there is a need for a high resolution image sensor that provides information concerning the reflected light in addition to information concerning the two primary light components (as discussed above), so that more accurate determinations of plant activity may be made by an operator.

### SUMMARY OF THE INVENTION

The present invention relates to an apparatus for producing a plurality of video signals to be processed by an image processor. The video signals are representative of light reflected from a source region external to the apparatus. The apparatus includes a light receiving unit for receiving the light reflected from the source region and a multi-spectral sensor coupled to the light receiving unit for converting the light received by the light receiving unit into the video signals. The sensor includes a light-separating device, a plurality of light-detecting arrays, and a sensor control circuit including a plurality of integration control circuits. The light-separating device divides the light received by the light receiving unit into a plurality of light components. Each array includes a plurality of pixels for receiving one of the plurality of light components from the light-separating device and for producing electronic signals in response thereto. Each integration control circuit controls the responsiveness of the pixels of one of the light-detecting arrays to the respective received light component. The sensor control circuit also converts the electronic signals into the video signals.

In another embodiment of the invention, the sensor includes a light-separating device for dividing the light received by the light receiving unit into a first, a second, and a third light component, and a first, a second, and a third CCD array for receiving the first, the second, and the third light component, respectively, and for converting the respective light component into a first, a second, and a third electronic signal, respectively. Also included is a sensor control circuit for converting the first, the second, and the third electronic signals into the video signals. At least one of the light components includes an infrared light component.

In another embodiment of the invention, the sensor includes a light-separating device for dividing the light received by the light receiving unit into a plurality of light components, at least three filters for removing a plurality of subcomponents from the light components to produce a plurality of filtered light components, a plurality of CCD arrays for receiving the filtered light components and for producing electronic signals in response to the filtered light components, and a sensor control circuit for converting the electronic signals into the video signals.

The present invention also relates to an apparatus for producing a plurality of electronic signals and for determining a normalized nitrogen status based on the electronic signals using a nitrogen classification algorithm. The electronic signals are representative of light reflected from a source region external to the apparatus. The apparatus includes a light receiving unit for receiving the light reflected from the source region, a multi-spectral sensor coupled to the light receiving unit for converting the light received by the light receiving unit into the electronic signals, and an image processor configured to calculate a reflective index representing the reflected light based upon the electronic signals, and to calculate the normalized nitrogen status using the reflective index and an additional system parameter. The sensor includes a light-separating device, a plurality of light-detecting arrays and a sensor control circuit. The light-separating device divides the light received by the light receiving unit into a plurality of light components. Each array includes a plurality of pixels for receiving one of the plurality of light components from the light-separating device and for producing the electronic signals in response thereto. The sensor control circuit includes a plurality of integration control circuits, where each integration control circuit is configured to control the integration time of the pixels of one of the light-detecting arrays.

The present invention further relates to an apparatus for producing a plurality of electronic signals and for determining a quantity representative of light reflection. The electronic signals are representative of light reflected from a source region external to the apparatus. The apparatus includes a light receiving unit for receiving the light reflected from the source region, a multi-spectral sensor coupled to the light receiving unit for converting the light received by the light receiving unit into the electronic signals, and an image processor that is coupled to the multi-spectral sensor and calculates a first quantity indicative of light reflection. The sensor includes a light-separating device for dividing the light received by the light receiving unit into a plurality of light components, a plurality of light-detecting arrays, and a sensor control circuit. Each array includes a plurality of pixels for receiving one of the plurality of light components from the light-separating device and for producing the electronic signals in response thereto. The sensor control circuit includes a plurality of integration control circuits, where each integration control circuit is configured to control the responsiveness of the pixels of one of the light-detecting arrays to the respective received light component.

The present invention also relates to an apparatus for producing a plurality of electronic signals to be processed by an image processor, where the electronic signals are representative of light reflected from a source region external to the apparatus. The apparatus includes a light receiving unit for receiving the light reflected from the source region, and a multi-spectral sensor coupled to the light receiving unit for converting the light received by the light receiving unit into the electronic signals. The sensor includes a light-separating device, a light-detecting array, a gain control circuit and an ambient light sensor. The light-separating device divides the light received by the light receiving unit into a plurality of light components. The light-detecting array includes a plurality of pixels for receiving one of the plurality of light components from the light-separating device and for producing the electronic signals in response thereto. The gain control circuit is coupled to the light detecting array and the ambient light sensor is coupled to the gain control circuit. The ambient light sensor provides an ambient light signal indicative of an ambient light level to the gain control circuit, and the gain control circuit provides a gain control signal to the light detecting array based upon the ambient light signal, so that the gain of the light detecting array varies in dependence upon the ambient light level.

The present invention further relates to a method of producing a plurality of video signals to be processed by an image processor. The video signals are representative of light reflected from a source region. The method includes receiving light reflected from the source region, dividing the received light into a plurality of light components, and sensing the light components at a plurality of pixels of a plurality of CCD arrays. The method also includes providing a plurality of electronic signals from the CCD arrays to a sensor control circuit in response to the sensing of the light components, converting the electronic signals from the CCD arrays into the video signals, and controlling the responsiveness of the pixels to the light components using a plurality of integration control circuits coupled to the CCD arrays.

The present invention also relates to a method of producing a plurality of electronic signals and of determining a normalized nitrogen status based on the electronic signals using a nitrogen classification algorithm. The electronic signals are representative of light reflected from a source region. The method includes receiving light reflected from the source region, dividing the received light into a plurality of light components, and sensing the light components at a plurality of pixels of a plurality of CCD arrays. The method further includes providing the plurality of electronic signals from the CCD arrays to a sensor control circuit in response to the sensing of the light components, controlling the integration times of the pixels using a plurality of integration control circuits coupled to the CCD arrays, calculating a reflective index representative of the reflected light based upon the electronic signals, and calculating the normalized nitrogen status using the reflective index and an additional system parameter.

The present invention further relates to a method of producing a plurality of electronic signals to be processed by an image processor and of determining a quantity indicative of light reflectance. The electronic signals are representative of light reflected from a source region. The method includes receiving light reflected from the source region, dividing the received light into a plurality of light components and sensing the light components at a plurality of pixels of a plurality of CCD arrays. The method further includes providing the plurality of electronic signals from the CCD arrays to a sensor control circuit in response to the sensing of the light components, controlling the responsiveness of the pixels to the light components using a plurality of integration control circuits coupled to the CCD arrays, measuring ambient light external to the apparatus, generating an ambient light signal indicative of the ambient light, and calculating a first quantity indicative of light reflectance based upon the ambient light signal using an image processor coupled to the multi-spectral sensor.

The present invention also relates to a method of producing a plurality of electronic signals to be processed by an image processor, where the electronic signals are representative of light reflected from a source region. The method includes receiving light reflected from the source region, dividing the received light into a plurality of light components, and sensing one of the light components at a light detecting array. The method further includes generating a gain control signal based upon an ambient light level, providing the gain control signal to the light detecting array, and producing the electronic signals in response to the sensing of the light component, wherein the electronic signals vary in dependence upon the gain control signal.

### BRIEF DESCRIPTION OF THE DRAWINGS

FIG. 1 is a block diagram of an imaging system according to the present invention.

FIG. 2 is a block diagram of the components of the multi-spectral sensor and the light receiving circuit according to the present invention.

FIG. 3 is a diagram of the images which are processed for the vegetation image according to the present invention.

FIG. 4 is a histogram of pixel gray scale values used to segment vegetation and non-vegetation images according to the present invention.

FIG. 5 is a graph showing the variation in output signal strength from a CCD array as a function of the integration time.

FIG. 6 is a block diagram of the components of the multi-spectral sensor and the light receiving circuit according to the preferred embodiment of the present invention, which includes three gain control circuits.

### DESCRIPTION OF THE PREFERRED EMBODIMENTS

While the present invention is capable of embodiment in various forms, there is shown in the drawings and will hereinafter be described a presently preferred embodiment with the understanding that the present disclosure is to be considered as an exemplification of the invention, and is not intended to limit the invention to the specific embodiment illustrated.

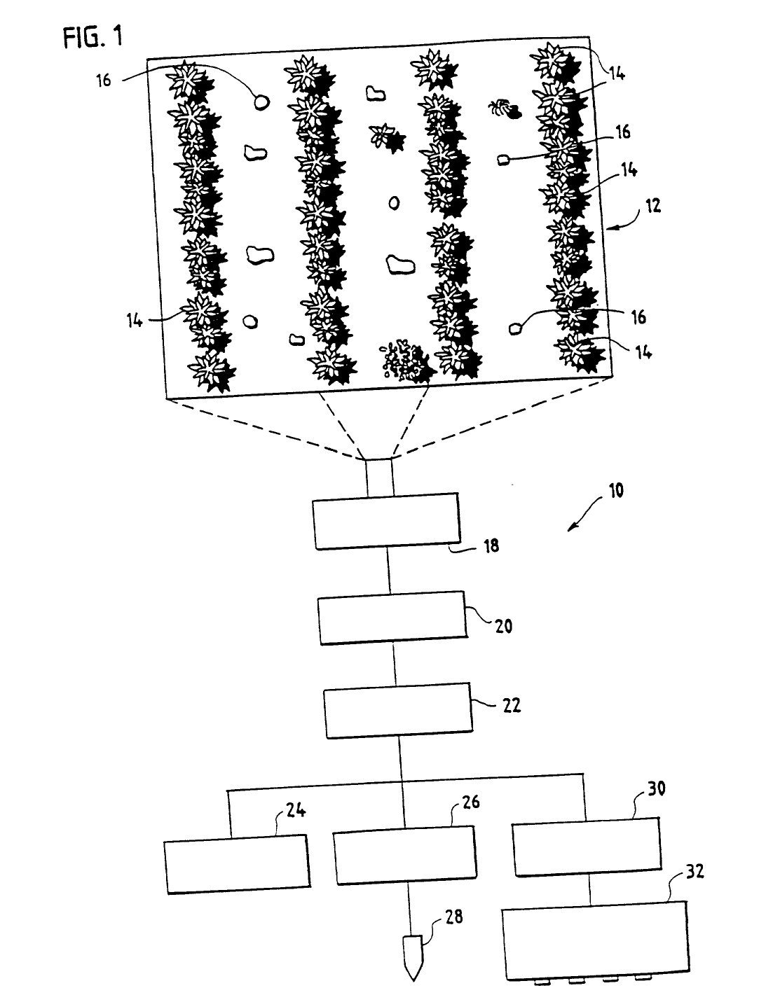

FIG. 1 shows a block diagram of an imaging system 10 which embodies the principles of the present invention. The imaging system 10 produces an image of vegetation from an area 12 having vegetation 14 and a non-vegetation background 16. The area 12 may be a field of any dimension in which analysis of the vegetation 14 for crop growth characteristics is desired. The present imaging system 10 is directed toward determination of nitrogen levels in the vegetation 14, although other crop growth characteristics may be determined as will be explained below.

The vegetation 14 are typically crops which are planted in rows or other patterns in the area 12. The vegetation 14 in the preferred embodiment includes all parts of the crops such as the green parts of crops which are exposed to light, non-green parts of crops such as corn tassels and green parts which are not exposed to light (shadowed). In certain applications of the preferred embodiment such as nitrogen characterization, the images of vegetation 14 will only include green parts of crops which are exposed to light particularly direct light. Other plant parts are not considered parts of the vegetation 14 which will be imaged. Other applications such as crop canopy analysis will include all parts of the crops as the image of vegetation 14.

The imaging system 10 has a light receiving unit 18 which detects light reflected from the vegetation 14 and the non-vegetation background 16 at a plurality of wavelength ranges. In the preferred embodiment, the light receiving unit 18 senses light reflected in three wavelength ranges, near infrared, red and green. The optimal wavelengths for crop characterization are green in the wavelength range of 550 nm (+/−20 nm), red in the wavelength range of 670 nm (+/−40 nm) and near infrared in the wavelength range of 800 nm (+/−40 nm). Of course, different bandwidths may be used. Additionally, the specific optimized wavelengths may depend on the type of vegetation being sensed.

The size of the area of view of the area 12 depends on the proximity of the imaging system 10 to the area 12 and the focal length of light receiving unit 18. A more detailed image may be obtained if the system 10 is in closer proximity to the area 12 and/or a smaller focal length lens is used. In the preferred embodiment, the imaging system 10 is mounted on a stable platform such as a tractor and the area of view is approximately 20 by 15 feet.

Larger areas of land may be imaged if the system 10 is mounted on an aerial platform such as an airplane, helicopter or a satellite. When the system 10 is mounted on an aerial platform a larger imaging array may be used in order to capture large areas with sufficient spatial and spectral resolution. Alternatively, several small images of a large area can be combined into an image map when used in conjunction with global positioning system (GPS) data.

Light receiving unit 18 is coupled to a multi-spectral sensor 20 to produce a multi-spectral image of the vegetation and non-vegetation based on the light reflected at the various wavelength ranges. An image processor 22 is coupled to the multi-spectral sensor 20 to produce a vegetation image by separating the non-vegetation portion from the vegetation portion of the multi-spectral image as a function of light reflected at the first wavelength range (near infrared) and light reflected at the second wavelength range (red).

The vegetation image is analyzed based on the third wavelength range (green). The image processor 22 includes a program for analyzing the vegetation image to determine the nitrogen status of the crop. This analysis may convert the observed reflectance levels to determine the amount of a substance such as nitrogen or chlorophyll in the vegetation and the amount of crop growth. Alternatively, one wavelength range may be used for both separating the non-vegetation portion from the vegetation portion as well as performing analysis on the vegetation image.

A storage device 24 is coupled to the image processor 22 for storing the vegetation image. The storage device 24 may be any form of memory device such as random access memory (RAM) or a magnetic disk. A geographic information system (GIS) 26 is coupled to the storage device 24 and serves to store location data with the stored vegetation images. Geographic information system 26 is coupled to a geographic position sensor 28 which provides location data. The position sensor 28, in the preferred embodiment, is a global positioning system receiver although other types of position sensors may be used.

The geographic information system 26 takes the location data and correlates the data to the stored image. The location data may be used to produce a crop map which indicates the location of individual plants or rows. The location data may be also used to produce a vegetation map. Alternatively, if the system 10 is mounted aerially, the location data may be used to assemble a detailed vegetation map using smaller images.

The image processor 22 may also be coupled to a corrective nitrogen application controller 30. Since the above analysis may be performed in real time, the resulting data may be used to add fertilizer to areas which do not have sufficient levels of nitrogen as the sensor system 10 passes over the deficient area. The controller 30 is connected to a fertilizer source 32. The controller 30 uses the information regarding nitrogen levels in the vegetation 14 from image processor 22 and determines whether corrective nitrogen treatments in the form of fertilizer are necessary. The controller 30 then applies fertilizer in these amounts from the fertilizer source 32. The fertilizer source includes any fertilizer application device, including those that are pulled by a tractor or are self-propelled. The fertilizer source may also be applied using irrigation systems.

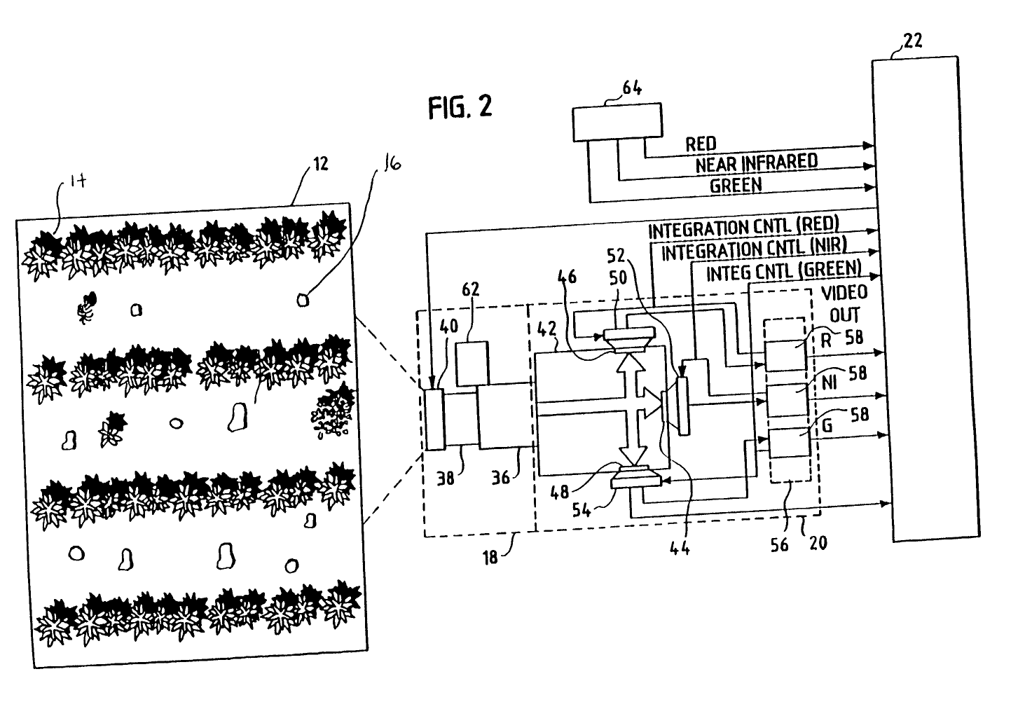

FIG. 2 shows the components of the light receiving unit 18, the multi-spectral sensor 20, and the image processor 22. The light receiving unit 18 in the preferred embodiment has a front section 36, a lens body 38 and an optional section 40 for housing an electronic iris. The electronic iris may be used to control the amount of light exposed to the multi-spectral sensor 20. The scene viewed through the lens 38 of the area 12 is transmitted to a prism box 42. The prism box 42 splits the light passing through the lens 38 to a near infrared filter 44, a red filter 46 and a green filter 48. Thus the light passed through the lens 38 is broken up into light reflected at each of the three wavelengths. The light at each of the three wavelengths from the prism box 42 is transmitted to other components of the multi-spectral sensor 20.

The multi-spectral sensor 20 contains three charge coupled device (CCD) arrays 50, 52 and 54. The light passes through near infrared filter 44, red filter 46, and green filter 48, and then is radiated upon charge coupled device (CCD) arrays 52, 50, and 54, respectively. The CCD arrays 50, 52 and 54 convert photon to electron energy when they are charged in response to signals received from integrated control circuits 58, described below. The CCD arrays 50, 52 and 54 may be exposed to light for individually varying exposure period by preventing photon transmission after a certain exposure duty cycle.

The CCD arrays 50, 52 and 54 convert the scene viewed through the lens 38 of the vegetation 14 and non-vegetation 16 of the area 12 into a pixel image corresponding to each of the three wavelength ranges. The CCD arrays 50, 52 and 54 therefore individually detect the same scene in three different wavelength ranges: red, green and near infrared ranges in the preferred embodiment. Accordingly, multi-spectral sensor 20 is adapted to provide two or more images in two or more wavelength bands or spectrums, and each of the images are taken by the same scene by light receiving unit 18.

In the preferred embodiment, each of the CCD arrays 50, 52 and 54 have 307, 200 detector elements or pixels which are contained in 640×480 arrays. Each detector element or pixel in the CCD arrays 50, 52 and 54 is a photosite where photons from the impacting light are converted to electrical signals. Each photosite thus produces a corresponding analog signal proportional to the amount of light at the wavelength impacting that photosite.

While the CCD arrays preferably have a resolution of 640 by 480 pixels, arrays having a resolution equal to or greater than 10 by 10 pixels may prove satisfactory depending upon the size of the area to be imaged. Larger CCD arrays may be used for greater spatial or spectral resolution. Alternatively, larger areas may be imaged using larger CCD arrays. For example, if the system 10 is mounted on an airplane or a satellite, an expanded CCD array may be desirable.

Each pixel in the array of pixels receives light from only a small portion of the total scene viewed by the sensor. The portion of the scene from which each pixel receives light is that pixel's viewing area. The size of each pixel's viewing area depends upon the pixel resolution of the CCD array of which it is a part, the optics (including lens 38) used to focus reflected light from the imaged area to the CCD array, and the distance between unit 18 and the imaged areas. For particular crops, there are preferred pixel viewing areas and system 10 should be configured to provide that particular viewing area. For crops such as corn and similar leafy plants, when the system is used to measure crop characteristics at later growth stages, the area in the field of view of each pixel should be less than 100 square inches. More preferably, the area should be less than 24 square inches. Most preferably, the area should be less than 6 square inches. For the same crops at early growth stages, the area in the field of view of each pixel should be no more than 24 square inches. More preferably, the area should be no more than 6 square inches, and most preferably, the area should be no more than 1 square inch.

CCD arrays 50, 52 and 54 are positioned in multi-spectral sensor 20 to send the analog signals generated by the CCD arrays representative of the green, red and near infrared radiation to a sensor control circuit 56 (electronically coupled to the CCD arrays) which converts the three analog signals into three video signals (red, near infrared and green) representative of the red, near infrared and green analog signals, respectively. The video signals are transmitted to the image processor 22. The data from these signals is used for analysis of crop characteristics of the imaged vegetation (i.e., vegetation 14 in the area 12). If desired, these signals may be stored in storage device 24 (see FIG. 1) for further processing and analysis.

Sensor control circuit 56 includes three integration control circuits 58 which have control outputs coupled to the CCD arrays 50, 52 and 54 to control the duty cycle of the pixels' collection charge and prevent oversaturation and/or the number of pixels at noise equivalent level of the pixels in the CCD arrays 50, 52 and 54. The noise equivalent level is the CCD output level when no light radiates upon the light-receiving surfaces of a CCD array. Such levels are not a function of light received, and therefore are considered noise. One or more integration control circuits 58 include an input coupled to the CCD array 54. The input measures the level of saturation of the pixels in CCD array 54 and the integration control circuit 58 determines the duty cycle for all three CCD arrays 50, 52 and 54 based on this input. The green wavelength light detected by CCD array 54 provides the best indication of oversaturation of pixel elements.

The exposure time of the CCD arrays 50, 52 and 54 is typically varied between one sixtieth and one ten thousandth of a second in order to keep the CCD dynamic range below the saturation exposure but above the noise equivalent exposure. Alternatively, the duty cycle for the other two CCD arrays 50 and 52 may be determined independently of the saturation level of CCD array 54. This may be accomplished by separate inputs to integration control circuits 58 and separate control lines to CCD arrays 50 and 52.

One or more integration control circuits 58 may also control the electronic iris of section 40. The electronic iris of section 40 has a variable aperture to allow more or less light to be passed through to the CCD arrays 50, 52 and 54 according to the control signal sent from at least one integration control circuit 58. Thus, the exposure of the CCD arrays 50, 52 and 54 may be controlled by the iris 40 to shutter light or the duty cycle of the pixels or a combination depending on the application.

The analog signals are converted into digital values for each of the pixels for each of the three images at green, red and near infrared. These digital values form digital images that are combined into a multi-spectral image which has a green, red and near infrared value for each pixel. The analog values of each pixel may be digitized using, for example, an 8 bit analog-to-digital converter to obtain reflectance values (256 colors) at each wavelength for each pixel in the composite image, if desired. Of course, higher levels of color resolution may be obtained with a 24 bit analog-to-digital converter (16.7 million colors).

The light receiving unit 18 can also include a light source 62 which illuminates the area 12 of vegetation 14 and non-vegetation 16 sensed by the light receiving unit 18. The light source 62 may be a conventional lamp which generates light throughout the spectrum range of the CCD arrays. The light source 62 is used to generate a consistent source of light to eliminate the effect of background conditions such as shade, clouds, etc. on the ambient light levels reaching the area 12.

Additionally, the imaging system 10 can include an ambient light sensor 64. The ambient light sensor 64 is coupled to the image processor 22 and provides three output signals representative of the ambient red, near infrared and green light, respectively, around the area 12. The output of the ambient light sensor 64 may be used to quantify reflectance measurement in environments in which the overall light levels change. In particular, the output of the ambient light sensor may be used to enable correction of the observed reflectance to account for changes in ambient light. A change in reflectance may be caused either by a change in the vegetation characteristics or by a change in ambient light intensity. Although primary control of CCD duty cycle is based upon direct CCD response, the processor 22 may control the integration control circuits 58 to adjust the exposure time of the CCD arrays 50, 52 and 54 to changes in reflectance and therefore maintain the output within a dynamic range.

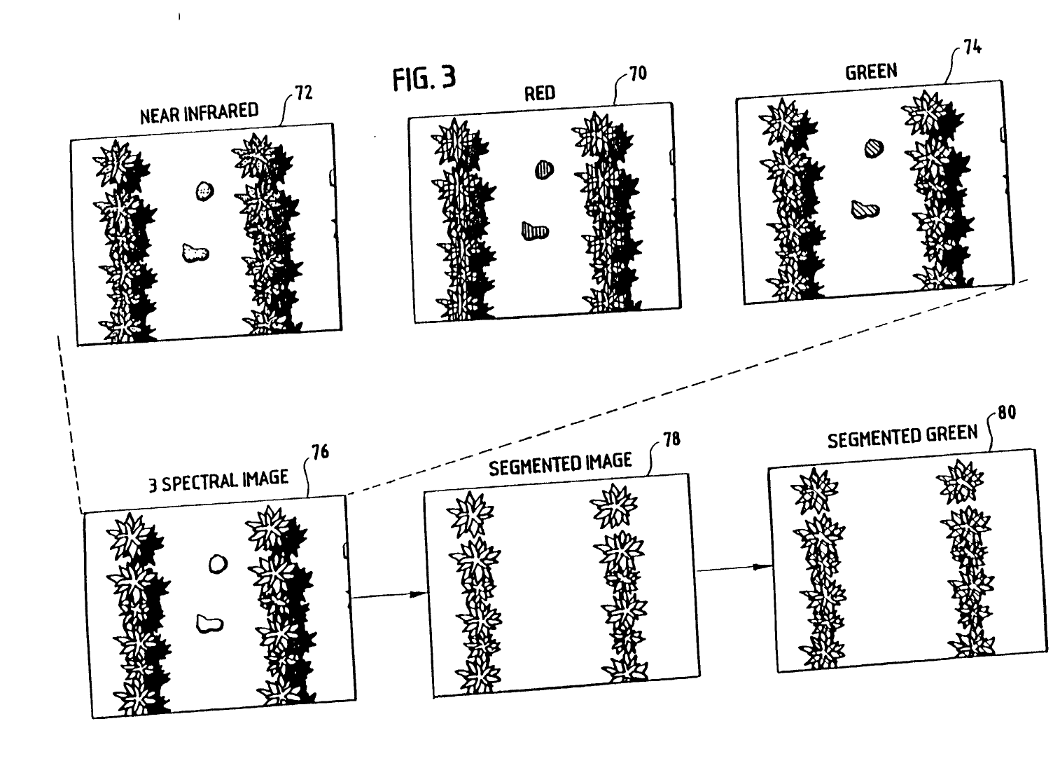

The operation and analysis procedure of the imaging system 10 will now be explained with reference to FIGS. 1-4. The imaging system 10 is used to determine crop characteristics. The imaging system 10 first senses light reflected from the vegetation 14 and the non-vegetation 16 of the area 12 at a plurality of wavelength ranges using the light receiving unit 18 as described above. The light receiving unit 18 separates the light reflected from the area 12 into a plurality of wavelength ranges. As explained above, there are three wavelengths and images are formed for light reflected at each of the wavelengths. As FIG. 3 shows, a red image 70, a near infrared image 72, and a green image 74 are formed from the CCD arrays 50, 52 and 54, respectively, of the multi-spectral sensor 20.

After the light is sensed at the three wavelength ranges, a multi-spectral image 76 is formed based on the sensed light at the plurality of wavelength ranges by the image processor 22. The multi-spectral image 76 is a combination of the three separate images 70, 72 and 74 at the red, near infrared and green wavelengths. A vegetation image 78 is obtained from the multi-spectral image 76 by analyzing light reflected at a first wavelength range and light reflected at a second wavelength range. Light reflected by the vegetation image 78 is determined at a third wavelength range to form a green vegetation image 80. Alternatively, the vegetation image 78 may be obtained by analyzing light reflected at a first wavelength range alone.

The quantity of a substance in the vegetation 14 is determined as a function of the light reflected by the vegetation image 78 at the third wavelength range such as the green vegetation image 80. Light reflectance in the visible spectrum (400-700 nm) increases with nitrogen deficiency in vegetation. Thus, sensing light reflectance allows a determination of the nitrogen in vegetation areas. Alternatively, the quantity of a substance such as nitrogen may be determined as a function of the light reflected by the vegetation image 78 at the first wavelength range alone.

Thus, the individual images 70, 72 and 74 at each of the three wavelengths may be combined to make a single multi-spectral image 76 by the image processor 22 or may be transmitted or stored separately in storage device 24 for further image processing and analysis. Additional processing may be performed on the vegetation image 78 to further distinguish features such as individual plants, shaded areas, etc. Alternatively, the present invention may be used with present images captured using color or color NIR film. Such film-based images are then digitized to provide the necessary spatial resolution. Such digitization may take an entire image. Alternatively, a portion of an image or several portions of an image may be scanned to assemble a map from different segments.

The image processor 22 is used to enhance the multi-spectral image 76, compute a threshold value for the image and produce the vegetation image 78. The enhancement step is performed in order to differentiate the vegetation and non-vegetation images in the composite image. As explained above, for purposes of characterizing crop nitrogen status, the vegetation includes only the green parts of a plant which are exposed to light, while the non-vegetation includes soil, tassels, shaded parts of plants, etc. Enhancement may be achieved by calculating an index using reflectance information from multiple wavelengths. The index is dependent on the type of feature which is desired to be enhanced. In the preferred embodiment, the vegetation features of the image are enhanced in order to perform crop analysis. However, other enhancements may include evaluation of soil, specific parts of plants, etc.

The index value for image enhancement is calculated for each pixel in the multi-spectral image 76. The index value in the preferred embodiment is derived from a formula which is optimal for separating vegetation from non-vegetation (i.e., soil areas). The preferred embodiment calculates a normalized difference vegetative index (NDVI) as an index value to separate the vegetation pixels from non-vegetation pixels. The NDVI index for each pixel is calculated by subtracting the red value from the near infrared value and dividing the result from the addition of the red value and the near infrared value. The vegetation image map is generated using the NDVI value for each pixel in the multi-spectral image.

A threshold value is computed based on the NDVI data for each pixel. An algorithm is chosen to compute a point that separates the vegetation areas from the non-vegetation areas. This point is termed the threshold and may be calculated using a variety of different techniques. In the preferred embodiment, a histogram of the NDVI values is calculated for all the pixels in the multi-spectral image. The NDVI values constitute a gray scale image composed of each of the pixels in the multi-spectral image.

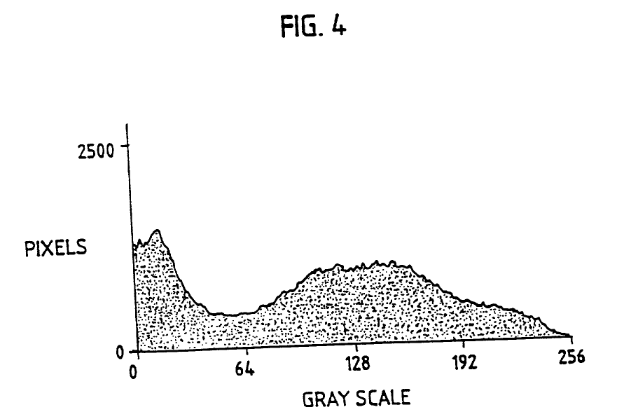

The histogram representing an NDVI gray scale image for multi-spectral image 76 is shown in FIG. 4. The histogram in FIG. 4 demonstrates the normal binary distribution between the soil (<64 gray level) and vegetation (>64 gray level). The threshold value is then calculated by an algorithm which best computes the gray level that separates the vegetation from the non-vegetation areas. In the preferred embodiment, the mean value for the gray scale for all the pixels in the multi-spectral image 76 is calculated. The mean is modified by an offset value to produce the threshold value. The offset value is obtained from a look up table having empirically derived gray scale values for different vegetation and non-vegetation areas obtained under comparable conditions. In FIG. 4, the threshold value is computed near gray level 64.

Each pixel's NDVI value is compared with the threshold value. If the NDVI value is below the threshold value, the pixel is determined to be non-vegetation and its reflectance values for all three wavelengths are set to zero which correspond to a black color. The pixels which have NDVI values above the threshold do not have their reflectance values altered. Thus, the resulting vegetation image 78 has only vegetation pixels representing the vegetation 14.

The image processor 22 then performs additional image analysis on the resulting vegetation image 78. The image analysis may be used to evaluate crop status in a number of ways. For example, plant nitrogen levels, plant population and percent canopy measurements may be characterized depending on how the vegetation image is filtered.

Crop nitrogen status may be estimated by the above described process since reflected green light is closely correlated with plant chlorophyll content and nitrogen concentration. Thus, determination of the average reflected green light over a given region provides the nitrogen and chlorophyll concentration. In this case, the NDVI values are used to select pixels which represent the green parts of the plants which are exposed to light. The reflective index may be computed from an entire image or it may be computed for selected areas within each image. The reflective index is computed for each pixel of an image in the preferred embodiment.

The average green reflective index (G_{avg n}) values for a particular area is computed as follows.

$${G}_{{avg}_{n}} = \frac{\sum {G}_{n} ( {x}_{c} , {y}_{c} )}{{c}_{n}} \qquad ( 1 )$$

In this equation, Gₙ is the green reflectance value for each of the individual pixels (x_{c} and y_{c}) in the vegetation area, n, for which the reflectance index is calculated and cₙ is the total number of pixels in the vegetation area.

Crop nitrogen status can also be estimated for a selected area of the vegetation image by calculating the ratio of light intensity at the third wavelength band to light intensity at the first wavelength band. This ratio is indicative of the crop nitrogen status. This ratio may be calculated by taking the ratio of the pixel value of a pixel receiving light in the third wavelength band and dividing this by a pixel value of a pixel receiving light in the first wavelength band. Alternatively, several such ratios may be calculated and the average taken of these ratios. Alternatively, an average value of pixels in the third wavelength band may be determined and an average value of pixels in the first wavelength band may be determined. The average pixel value for the third wavelength band may then be divided by the average pixel value for the first wavelength band. If this process is performed to estimate the nitrogen status for a selected area of the image, only those pixels that form the selected area would be employed.

A normalized nitrogen status may be obtained by using a nitrogen classification algorithm. This algorithm uses the computed reflective index and also incorporates ambient light measurements from the ambient light sensor 64 and settings such as the duty cycle of arrays 50, 52 and 54 (as well as the gain of arrays 50, 52 and 54 as discussed below). Including these non-vegetation parameters enables the system to correct for changes in observed reflectance due to ambient light levels and sensor system parameters.

More specifically, calculating a normalized nitrogen status requires a determination of the amount (proportion) of light being reflected from the scene (i.e., area 12), which requires (1) determining how much light is actually being radiated onto one or more of CCD arrays 50, 52 and 54, and (2) compensating for variations in how much light is actually incident upon the scene (e.g., the reflected light increases due to increases in sunlight even though the amount of vegetation present does not change). The fundamental purpose of multi-spectral sensor 20 is to measure the amount of light radiated on the photosites of CCD arrays 50, 52 and 54. Each of CCD arrays 50, 52 and 54 creates a two-dimensional image of the scene (i.e., area 12). The output of CCD arrays 50, 52 and 54 may be viewed as a digital image having pixels with gray level (“GL”) values representing light intensity. Because CCD arrays 50, 52 and 54 have limited dynamic range(s), and because the amount of light radiated on the CCD arrays may vary substantially in a changing, ambient agricultural environment (due both to variation in the incident, surrounding light, e.g., sunlight, and to variation in the scene itself, e.g., the amount of vegetation), integration control circuits 58 are employed to keep the CCD arrays within their dynamic range(s).

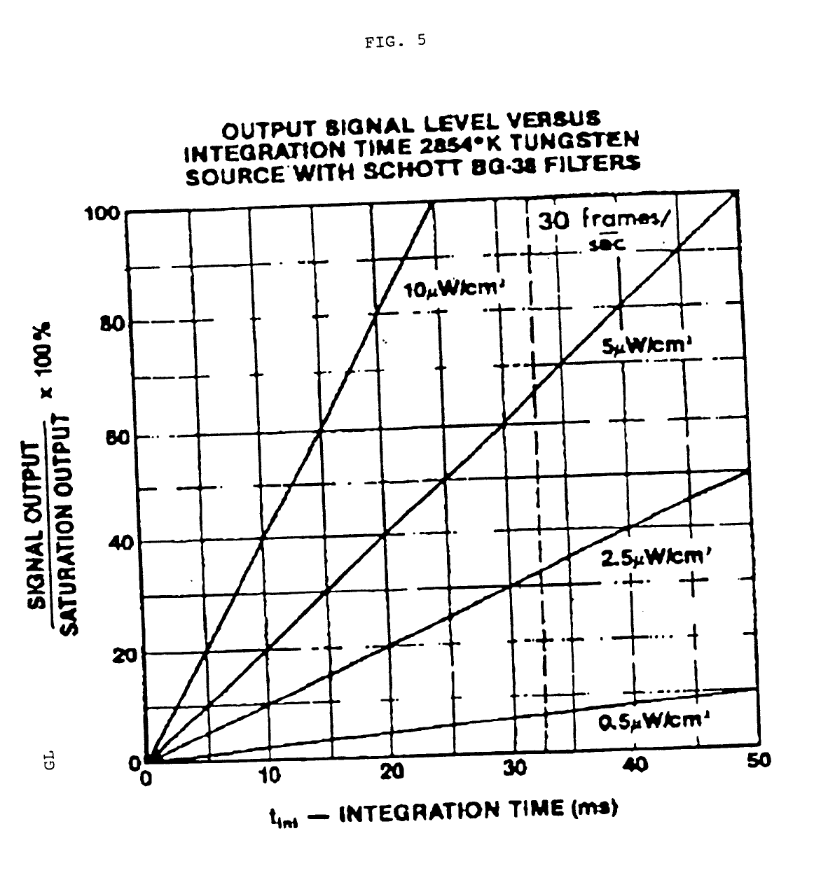

Integration control circuits 58 optimize the output of CCD arrays 50, 52 and 54 within their dynamic range(s) by setting the amount(s) of time the CCD arrays are exposed to the light radiated from the scene. The integration signal from an integration control circuit is synced with the framing rate of the CCD array (e.g., 30 Hz or 60 Hz) with which it is associated, and varies in pulse width. That is, the integration time may be represented as a % duty cycle (% DC) measurement with 0% being a zero-second integration time and 100% being a full 1/60^{th} of a second (or vice-versa, depending upon the nature of the circuit logic). As the amount of light radiated on a CCD array increases, the integration time decreases, and vice-versa. Therefore, the output of the CCD array is primarily between the noise equivalent and the saturation levels of the CCD array. As shown in FIG. 5, the amount of light reflected from the scene and radiated on the CCD array is a function of integration time and the output of the CCD array (GL).

While information as to the integration time (or duty cycle) of a CCD array, when combined with information regarding the overall amount of radiation experienced by (i.e., the output of) the CCD array (GL), may be used to determine how much light is actually being radiated onto the CCD array, further information must be obtained concerning the surrounding, ambient light of the environment before an accurate measure of light reflectance may be calculated and, from that calculation, a nitrogen status may be obtained. Such information concerning the strength of ambient light may be obtained via ambient light sensor 64 and provided to image processor 22 (or another calculating device), which then would calculate light reflectance (and normalized nitrogen status) based upon the ambient light and light radiation information.

In one embodiment, nitrogen status is directly calculated from absolute reflectance energy, which is in turn calculated by image processor 22 (via an algorithm programmed within the image processor) as follows. As shown in FIG. 5, output signal strength from a CCD array (e.g., CCD array 50) varies in dependence upon the integration time (or duty cycle or pulse width) of the CCD array, which is controlled (as described above) by a related integration control circuit 58. Assuming no variation in ambient light, a quantity (referred to as absolute reflectance energy (R)) representing the absolute intensity of light reflected from the source region (containing vegetation and/or nonvegetation) is determined from the output signal strength and the integration time according to the following relationship (in which GL or “gray level” is representative of the CCD output signal strength and tᵢₙₜ is integration time):

R=GL/tᵢₙₜ (2)

FIG. 5 shows absolute reflectance energy as the slope of the graph of CCD output signal strength versus integration time. Therefore, as the absolute reflectance energy increases, a smaller integration time is required to obtain the same output signal strength.

While ambient light levels may not vary significantly under certain conditions, it is nonetheless common for ambient light levels to vary significantly (e.g., due to changes in the time of day, cloud cover and atmospheric conditions). In another embodiment of the invention, therefore, image processor 22 additionally calculates a normalized reflectance energy (Rₙₒᵣₘ) to account for variation in ambient light as measured by ambient light sensor 64. The normalized reflectance energy is calculated as follows (where AI represents ambient light intensity):

Rₙₒᵣₘ=R/AI=GL/(tᵢₙₜ*AI) (3)

or equivalently,

Rₙₒᵣₘ/R=1/AI (4)

As shown, the normalized reflectance energy equals the absolute reflectance energy divided by the ambient light intensity.

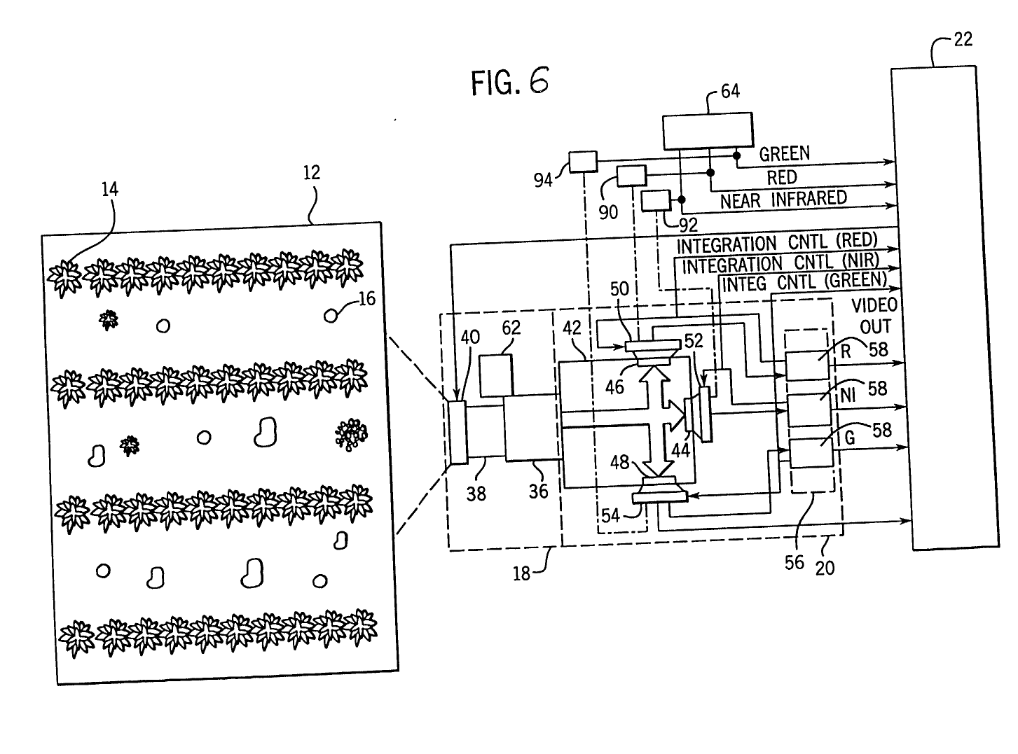

In a preferred embodiment, multi-spectral sensor 20 accounts for variation in the ambient light intensity in a second manner (in addition to calculating, by way of equation (3), the normalized reflectance energy) by adjusting the gain of one or more of CCD arrays 50, 52 and 54. As shown in FIG. 6, the preferred embodiment of multi-spectral sensor 20 includes red, near infrared and green gain control circuits 90, 92 and 94, respectively. Gain control circuits 90, 92 and 94 respectively receive red, near infrared and green ambient light intensity signals from ambient light sensor 64. In response, gain control circuits 90, 92 and 94 respectively provide gain control signals to CCD arrays 50, 52 and 54 to adjust the gain of the CCD arrays.

Gain control circuits 90, 92 and 94 determine the desired gain as a linear function of the ambient light intensity, although in alternate embodiments the relationship between desired gain and ambient light intensity may be nonlinear. Although three gain control circuits 90, 92 and 94 are shown in FIG. 6 as providing individual gain signals to each of CCD arrays 50, 52 and 54, in alternate embodiments only one or two gain control circuits may be employed to provide gain signals to one or more of the CCD arrays. Also, in alternate embodiments, instead of including separate gain circuits, multi-spectral sensor 20 may determine gain control signals at image processor 22 and then provide these signals to CCD arrays 50, 52 and 54 via additional control lines (not shown).

When, in the preferred embodiment, multi-spectral sensor 20 adjusts the gain of CCD arrays 50, 52 and 54, different equations than equations (2) and (3) are appropriate for calculating the absolute reflectance energy and the normalized reflectance energy. Specifically, the absolute reflectance energy is in this case calculated as follows:

R=(c*GL)/{tᵢₙₜ*10^{(s*g)}} (5)

Further, the normalized reflectance energy is calculated as follows:

Rₙₒᵣₘ=R/AI=(c*GL)/{tᵢₙₜ*10^{(s*g)}*AI} (6)

In equations (5) and (6), the factor 10^{(s*g)} is a gain factor representing the gain of a CCD array in decibels. Specifically, g is the sensor gain in volts, while s is a gain calibration constant. Also, c is a calibration constant employed so that the absolute reflectance energy is in a standard dimension (e.g., W/m²). (In alternate embodiments, multi-spectral sensor 20 may be configured to adjust only the gain of CCD arrays 50, 52 and 54 rather than to adjust both the gain and the integration times of the CCD arrays.)

Another corrective measure for vegetation factors involves sensing a reference strip of vegetation having a greater supply of nitrogen. This reference strip may consist of rows of plants which are given 10-20% more nitrogen than is typically recommended for the crop, thus insuring that the lack of nitrogen does not limit crop growth and chlorophyll levels. The reference plants are located at specific intervals depending on the regions or areas where the reflective indexes are to be calculated.

A reference reflectance value is calculated from the reference strip by the process described above. The reflective index of the other areas can be compared directly to the reference N reflectance value. Direct comparison of the crop reflectance at the green wavelength with reflectance from an adjacent reference strip will ensure that differences in observed reflectance are due solely to nitrogen deficiency and not to low light levels or other stress factors that may have impacted reflectance from the crop.

The system 10 may be used to compile a larger crop map of a field in which a crop is growing. To create this map, the system receives and stores a succession of individual images of the crop each taken at a different position in the field. The position sensor 28 is used to obtain location coordinates, substantially simultaneous to receiving each image, indicative of the location at which each of the images was received. The location coordinates are stored in a manner that preserves the relationship between each image and its corresponding location coordinates. As each vegetation image is processed, it is combined with other vegetation images to form a vegetation map of a larger area.

Crop growth may also be determined by system 10. To provide this determination, a first image may be taken of the crop at a particular location and recorded. Subsequent images may be taken and recorded at varying time intervals, such as weekly, biweekly or monthly. The amount of crop growth over each such interval may then be determined by comparing the first recorded images with subsequent recorded images at the same location.

The stored vegetation images may be used for further analysis, such as to determine plant population. Additionally, in conjunction with the location data obtained from the position sensor 28, the positions of individual plants from the vegetation image may be determined. Further analysis may be performed by isolating an image of a specific row of vegetation. This analysis may be performed using the stored digital images and software tailored to enhance images.

The above identified data may then be used for comparison of crop factors such as tillage, genotype used and fertilizer effects.

It will be apparent to those skilled in the art that various modifications and variations can be made in the apparatus and method of the present invention without departing from the spirit or scope of the invention. For example, the imaging sensor may be used in conjunction with soil property measurements such as type, texture, fertility and moisture analysis. Additionally, it may be used in residue measurements such as type or residue or percentage of residue coverage. Images can also be analyzed for weed detection or identification purposes.

The invention is not limited to crop sensing applications such as nitrogen analysis. The light receiving unit and image processor arrangement may be used in vehicle guidance by using processed images to follow crop rows, recognize row width, follow implement markers and follow crop edges in tillage operations. The sensor arrangement may also be used in harvesting by measuring factors such as grain tailings, harvester swath width, numbers of rows, cutter bar width or header width and monitoring factors such as yield, quality of yield, loss percentage, or number of rows.

The imaging system of the present invention may also be used to aid vision by providing rear or alternate views or guidance error checking. The system may also be used in conjunction with obstacle avoidance. Additionally, the system may be used to monitor operator status such as human presence or human alertness.

Thus, it is intended that the present invention cover modifications and variations that come within the scope of the spirit of the invention and the claims that follow.

What is claimed is:

1. An apparatus for producing a plurality of video signals to be processed by an image processor, the video signals representative of light reflected from a source region external to the apparatus, the apparatus comprising:
a light receiving unit for receiving the light reflected from the source region; and
a multi-spectral sensor coupled to the light receiving unit for converting the light received by the light receiving unit into the video signals, the sensor comprising
a light-separating device for dividing the light received by the light receiving unit into a plurality of light components,
a plurality of light-detecting arrays, each including a plurality of pixels for receiving one of the plurality of light components from the light-separating device and for producing electronic signals in response thereto, and
a sensor control circuit including a plurality of integration control circuits, each integration control circuit configured to control the responsiveness of the pixels of one of the light-detecting arrays to the respective received light component, wherein the sensor control circuit is also configured to convert the electronic signals into the video signals.

2. The apparatus of claim 1, wherein each of the light-detecting arrays includes a charged-coupled device (CCD) array.

3. The apparatus of claim 2, wherein one of the integration control circuits receives an input signal from one of the CCD arrays, and the one integration control circuit controls the integration time of the one CCD array in response to the input signal.

4. The apparatus of claim 2, wherein the light receiving unit comprises an electronic iris having a variable aperture for varying the light received by the light receiving unit in response to an iris control signal generated by the sensor.

5. The apparatus of claim 2, wherein the CCD arrays include a first CCD array, a second CCD array, and a third CCD array, and wherein the integration control circuits include a first integration control circuit for controlling the integration time of the first CCD array, a second integration control circuit for controlling the integration time of the second CCD array, and a third integration control circuit for controlling the integration time of the third CCD array.

6. The apparatus of claim 5, wherein the first integration control circuit receives a first input signal from the first CCD array, and controls the integration time of the first CCD array in response to the first input signal.

7. The apparatus of claim 6, wherein the second integration control circuit and the third integration control circuit receive the first input signal from the first CCD array, and the second and third integration control circuits respectively control the integration times of the second and third CCD arrays in response to the first input signal.

8. The apparatus of claim 6, wherein the second integration control circuit receives a second input signal from the second CCD array, the third integration control circuit receives a third input signal from the third CCD array, the second integration control circuit controls the integration time of the second CCD array in response to the second input signal, and the third integration control circuit controls the integration time of the third CCD array in response to the third input signal.

9. The apparatus of claim 1, wherein one of the integration control circuits controls the responsiveness of the pixels of one of the light-detecting arrays by controlling a duty cycle of the pixels.

10. The apparatus of claim 9, wherein the one integration control circuit controls the duty cycle to prevent oversaturation of the pixels.

11. The apparatus of claim 9, wherein the one integration control circuit controls the duty cycle to prevent operation of the pixels at noise equivalent levels.

12. The apparatus of claim 1, wherein the electronic signals are analog signals, and the sensor includes an analog-to-digital converter for digitizing the electronic signals.

13. The apparatus of claim 2, wherein at least one of the CCD arrays has a resolution of at least 640 pixels by 480 pixels.

14. The apparatus of claim 2, wherein the sensor further comprises a plurality of filters, each filter optically coupled between the light-separating device and one of the CCD arrays, the filters configured to allow passage of different predetermined wavelengths of light.

15. The apparatus of claim 1, further comprising:
a gain control circuit coupled to one of the light detecting arrays, and
an ambient light sensor coupled to the gain control circuit, the ambient light sensor providing an ambient light signal indicative of an ambient light level to the gain control circuit, the gain control circuit providing a gain control signal to the light detecting array based upon the ambient light signal,
wherein the gain of the light detecting array varies in dependence upon the ambient light level.

16. An apparatus for producing a plurality of video signals to be processed by an image processor, the video signals representative of light reflected from a source region external to the apparatus, the apparatus comprising:
a light receiving unit for receiving the light reflected from the source region; and
a multi-spectral sensor coupled to the light receiving unit for converting the light received by the light receiving unit into the video signals, the sensor comprising
a light-separating device for dividing the light received by the light receiving unit into a first light component, a second light component and a third light component, wherein at least one of the light components includes an infrared light component,
a first, a second, and a third CCD array for receiving the first, the second, and the third light component, respectively, and for converting the respective light component into a first, a second, and a third electronic signal, respectively, and
a sensor control circuit for converting the first, the second, and the third electronic signals into the video signals.

17. The apparatus of claim 16, wherein the first light component includes the infrared light component, the second light component includes a red light component, and the third light component includes a green light component.

18. The apparatus of claim 17, wherein each CCD array includes a plurality of pixels, and wherein the sensor control circuit includes at least one integration control circuit for controlling the responsiveness of the pixels of at least one of the CCD arrays.

19. The apparatus of claim 16, further comprising
an ambient light sensor coupled to the image processor for measuring an ambient light level so that the video signals may be adjusted to account for changes in ambient light in the source region.

20. The apparatus of claim 18, wherein the ambient light sensor provides signals to the image processor that are representative of three components of the ambient light, the three ambient light components corresponding to the three components of light received by the CCD arrays.

21. The apparatus of claim 16, further comprising:
a gain control circuit coupled to one of the CCD arrays, and
an ambient light sensor coupled to the gain control circuit, the ambient light sensor providing an ambient light signal indicative of an ambient light level to the gain control circuit, the gain control circuit providing a gain control signal to the one CCD array based upon the ambient light signal,
wherein the gain of the CCD array varies in dependence upon the ambient light level.

22. The apparatus of claim 16, further comprising a light source, wherein the light source provides an additional source of light to the source region.

23. An apparatus for producing a plurality of video signals to be processed by an image processor, the video signals representative of light reflected from a source region external to the apparatus, the apparatus comprising:
a light receiving unit for receiving the light reflected from the source region; and
a multi-spectral sensor coupled to the light receiving unit for converting the light received by the light receiving unit into the video signals, the sensor comprising
a light-separating device for dividing the light received by the light receiving unit into a plurality of light components,
at least three filters for removing a plurality of subcomponents from the light components to produce a plurality of filtered light components,
a plurality of CCD arrays for receiving the filtered light components and for producing electronic signals in response to the filtered light components, and
a sensor control circuit for converting the electronic signals into the video signals.

24. The apparatus of claim 23, wherein a first of the filtered light components includes an infrared light component, a second of the filtered light components includes a red light component, and a third of the filtered light components includes a green light component.

25. The apparatus of claim 23, further comprising
an ambient light circuit configured to provide a gain control signal to one of the CCD arrays determined in response to an ambient light level,
wherein the gain of the one CCD array varies in dependence upon the ambient light level.

26. An apparatus for producing a plurality of electronic signals, the electronic signals representative of light reflected from a source region external to the apparatus, and for determining a normalized nitrogen status based on the electronic signals using a nitrogen classification algorithm, the apparatus comprising:
a light receiving unit for receiving the light reflected from the source region;
a multi-spectral sensor coupled to the light receiving unit for converting the light received by the light receiving unit into the electronic signals, the sensor comprising:
a light-separating device for dividing the light received by the light receiving unit into a plurality of light components,
a plurality of light-detecting arrays, each including a plurality of pixels for receiving one of the plurality of light components from the light-separating device and for producing the electronic signals in response thereto, and
a sensor control circuit including a plurality of integration control circuits, each integration control circuit configured to control the integration time of the pixels of one of the light-detecting arrays; and
an image processor configured to calculate a reflective index representing the reflected light based upon the electronic signals, and to calculate the normalized nitrogen status using the reflective index and an additional system parameter.

27. The apparatus of claim 26, wherein the additional system parameter is the integration time of the pixels of at least one of the light-detecting arrays.

28. The apparatus of claim 26, further comprising an ambient light sensor coupled to the image processor, the ambient light sensor configured to measure ambient light external to the apparatus and to provide an ambient light signal indicative of the ambient light to the image processor,
wherein the additional system parameter is the ambient light signal.

29. The apparatus of claim 28, wherein the normalized nitrogen status is calculated using also the integration time of the pixels of at least one of the light-detecting arrays.

30. The apparatus of claim 26, further comprising
a gain control circuit coupled to one of the light-detecting arrays, and
an ambient light sensor coupled to the gain control circuit, the ambient light sensor providing an ambient light signal indicative of an ambient light level to the gain control circuit, the gain control circuit providing a gain control signal to the one light-detecting array based upon the ambient light signal,
wherein the gain of the one light-detecting array varies in dependence upon the ambient light level.

31. The apparatus of claim 30, wherein the additional system parameter is the gain of the one light-detecting array.

32. An apparatus for producing a plurality of electronic signals, the electronic signals being representative of light reflected from a source region external to the apparatus, and for determining a quantity representative of light reflection, the apparatus comprising:
a light receiving unit for receiving the light reflected from the source region;
a multi-spectral sensor coupled to the light receiving unit for converting the light received by the light receiving unit into the electronic signals, the sensor comprising:
a light-separating device for dividing the light received by the light receiving unit into a plurality of light components,
a plurality of light-detecting arrays, each including a plurality of pixels for receiving one of the plurality of light components from the light-separating device and for producing the electronic signals in response thereto, and
a sensor control circuit including a plurality of integration control circuits, each integration control circuit configured to control the responsiveness of the pixels of one of the light-detecting arrays to the respective received light component; and
an image processor coupled to the multi-spectral sensor, the image processor calculating a first quantity indicative of light reflection.

33. The apparatus of claim 32, wherein the image processor calculates the first quantity as equal to a light-detecting array output signal divided by an integration time.

34. The apparatus of claim 32, further comprising an ambient light sensor coupled to the image processor, the ambient light sensor configured to measure ambient light external to the apparatus and to generate an ambient light signal indicative of the ambient light, wherein the image processor calculates a second quantity indicative of light reflectance based upon the first quantity and the ambient light signal.

35. The apparatus of claim 34, wherein the image processor calculates the first quantity as equal to a light-detecting array output signal divided by an integration time.

36. The apparatus of claim 32, further comprising a gain control circuit configured to determine the gain of one of the light-detecting arrays, wherein the first quantity indicative of light reflection is dependent upon the gain of the one light-detecting array.

37. An apparatus for producing a plurality of electronic signals to be processed by an image processor, the electronic signals representative of light reflected from a source region external to the apparatus, the apparatus comprising:
a light receiving unit for receiving the light reflected from the source region; and
a multi-spectral sensor coupled to the light receiving unit for converting the light received by the light receiving unit into the electronic signals, the sensor comprising:
a light-separating device for dividing the light received by the light receiving unit into a plurality of light components,
a light-detecting array including a plurality of pixels for receiving one of the plurality of light components from the light-separating device and for producing the electronic signals in response thereto,
a gain control circuit coupled to the light detecting array, and
an ambient light sensor coupled to the gain control circuit, the ambient light sensor providing an ambient light signal indicative of an ambient light level to the gain control circuit, the gain control circuit providing a gain control signal to the light detecting array based upon the ambient light signal, so that the gain of the light detecting array varies in dependence upon the ambient light level.

38. A method of producing a plurality of video signals to be processed by an image processor, the video signals representative of light reflected from a source region, the method comprising the steps of:
receiving light reflected from the source region;
dividing the received light into a plurality of light components;
sensing the light components at a plurality of pixels of a plurality of CCD arrays;
providing a plurality of electronic signals from the CCD arrays to a sensor control circuit in response to the sensing of the light components;
converting the electronic signals from the CCD arrays into the video signals; and
controlling the responsiveness of the pixels to the light components using a plurality of integration control circuits coupled to the CCD arrays.

39. The method of claim 38, wherein the plurality of light components includes at least three light components and at least one of the light components includes an infrared light component.

40. The method of claim 38, further comprising the step of filtering the light components by at least three filters to remove subcomponents from the light components, before sensing the light components.

41. The method of claim 40, further comprising the step of
determining an ambient light level at an ambient light sensor so that the video signals may be adjusted to account for changes in ambient light in the source region.

42. The method of claim 38, wherein the step of receiving the light is performed by an apparatus supported by a ground vehicle.

43. The method of claim 38, wherein the step of receiving the light is performed by an apparatus supported by an aircraft.

44. The method of claim 38, wherein the step of receiving the light is performed by an apparatus supported by a satellite.

45. A method of producing a plurality of electronic signals, the electronic signals representative of light reflected from a source region, and of determining a normalized nitrogen status based on the electronic signals using a nitrogen classification algorithm, the method comprising the steps of:
receiving light reflected from the source region;
dividing the received light into a plurality of light components;
sensing the light components at a plurality of pixels of a plurality of CCD arrays;
providing the plurality of electronic signals from the CCD arrays to a sensor control circuit in response to the sensing of the light components;
controlling the integration times of the pixels using a plurality of integration control circuits coupled to the CCD arrays;
calculating a reflective index representative of the reflected light based upon the electronic signals; and
calculating the normalized nitrogen status using the reflective index and an additional system parameter.

46. The method of claim 45, wherein the additional system parameter is the integration time of the pixels of at least one of the light-detecting arrays.

47. The method of claim 45, further comprising the steps of
measuring ambient light external to the apparatus at an ambient light sensor; and
generating an ambient light signal indicative of the ambient light,
wherein the additional system parameter is the ambient light signal.

48. A method of producing a plurality of electronic signals to be processed by an image processor, the electronic signals representative of light reflected from a source region, and of determining a quantity indicative of light reflectance, the method comprising the steps of:
receiving light reflected from the source region;
dividing the received light into a plurality of light components;
sensing the light components at a plurality of pixels of a plurality of CCD arrays;
providing the plurality of electronic signals from the CCD arrays to a sensor control circuit in response to the sensing of the light components;
controlling the responsiveness of the pixels to the light components using a plurality of integration control circuits coupled to the CCD arrays;
measuring ambient light external to the apparatus;
generating an ambient light signal indicative of the ambient light; and
calculating a first quantity indicative of light reflectance based upon the ambient light signal using an image processor coupled to the multi-spectral sensor.

49. The method of claim 48, wherein the first quantity is equal to a light-detecting array output signal divided by the product of the ambient light signal and an integration time.

50. A method of producing a plurality of electronic signals to be processed by an image processor, the electronic signals representative of light reflected from a source region, the method comprising the steps of:
receiving light reflected from the source region;
dividing the received light into a plurality of light components;
sensing one of the light components at a light detecting array;
generating a gain control signal based upon an ambient light level;
providing the gain control signal to the light detecting array; and
producing the electronic signals in response to the sensing of the light component, wherein the electronic signals vary in dependence upon the gain control signal.
